(19) United States
(12) Patent Application Publication
(10) Pub. No.: US 2009/0220858 A1
(43) Pub. Date: Sep. 3, 2009

(54) Composite Compound With Mixed Crystalline Structure

(75) Inventors: Tangli Cheng, Shenzhen (CN); Long He, Shenzhen (CN); Zhanfeng Jiang, Shenzhen (CN); Ye Tian, Shenzhen (CN); Junfeng Liu, Shenzhen (CN)

Correspondence Address: GREENBERG TRAURIG, LLP (SV);IP DOCKETING, 2450 COLORADO AVENUE, SUITE 400E, SANTA MONICA, CA, 90404, US

(73) Assignee: BYD COMPANY LIMITED, Shenzhen (CN)

(21) Appl. No.: 12/040,773

(22) Filed: Feb. 29, 2008

(51) Int. Cl. H01M 4/58; H01B 1/08; H01M 4/56

(52) U.S. Cl. 429/220; 252/520.22; 252/520.1; 252/520.4; 252/520.5; 252/521.2; 252/521.3; 252/521.4; 252/521.5; 252/519.4; 252/518.1; 252/521.1; 252/520.2; 252/506; 252/510; 429/231.95; 429/221; 429/224; 429/223; 429/231.5; 429/231.6; 429/228; 429/227

(57) ABSTRACT

Described is a composite lithium compound having a mixed crystalline structure. Such compound was formed by heating a lithium compound and a metal compound together. The resulting mixed metal crystal exhibits superior electrical property and is a better cathode material for lithium secondary batteries.

### FIELD OF THE INVENTION

The embodiments of the present invention relate to lithium secondary batteries, more specifically, to a composite compound having a mixed crystalline structure that can be used as a cathode material for lithium secondary batteries.

### BACKGROUND

Lithium secondary batteries are widely used in various devices such laptops, cameras, camcorders, PDAs, cell phones, iPods and other portable electronic devices. These batteries are also growing in popularity for defense, automotive and aerospace applications because of their high energy density.

Lithium phosphate-based cathode materials for secondary battery have long been known in the battery industry. People have used metal intercalation compound to improve the electrical property of lithium phosphate. One popular intercalation compound is lithium iron phosphate (LiFePO₄). Because of its non-toxicity, excellent thermal stability, safety characteristics and good electrochemical performance, there is a growing demand for rechargeable lithium secondary batteries with LiFePO₄ as the cathode material.

LiFePO₄ has its problems as a cathode material, however. Compared with other cathode materials such as lithium cobaltate, lithium nicklate, and lithium magnate, LiFePO₄ has much lower conductance and electrical density. The current invention solves the problem by producing a mixed crystal structure to significantly enhance the electrical properties of LiFePO₄.

A mixed crystal can sometimes be referred to as a solid solution. It is a crystal containing a second constituent, which fits into and is distributed in the lattice of the host crystal. See IUPAC Compendium of Chemical Terminology 2nd Edition (1997). Mixed crystals have been used in semiconductors for enhancing light output in light emitting diodes (LEDs). They have also been used to produce sodium-based electrolyte for galvanic elements. The current invention is the first time that a mixed crystal has been successfully prepared for lithium metal intercalation compounds such as LiFePO₄. It is also the first time that a mixed crystalline structure has been used as a cathode material for lithium secondary batteries. The new cathode material disclosed in the present invention has significantly better electrical properties than traditional LiFePO₄ cathode materials.

### SUMMARY

Accordingly, a first embodiment of the present invention discloses a substance comprising at least one lithium compound and at least one metal compound, wherein the metal compound is distributed into the lithium compound to form a composite compound with enhanced electrical properties. In one preferred embodiment, the composite compound has a mixed crystalline structure. In one particular example of the invention, the lithium compound is a metal intercalation compound that has the general formula LiMₐN_{b}XO_{c}, wherein M is a first-row transition metal including Fe, Mn, Ni, V, Co and Ti; N is a metal selected from the group Fe, Mn, Ni, V, Co, Ti, Mg, Ca, Cu, Nb, Zr and rare-earth metals; X is selected from elements P, Si, S, V and Ge; and a, b and c have respective values that would render said metal intercalation compound charge-neutral. In one embodiment, the metal compound has the general formula MCNd, wherein M is metal selected from IA, IIA, IIIA, IVA, VA, IIIB, IVB and IVB groups in the periodic table; N is selected from O, N, H, S, SO₄, PO₄, OH, Cl, F, and C; and 0<c≦4 and 0<d≦6. In other embodiments, the metal compounds may include one or more members selected from the group consisting of MgO, SrO, Al₂O₃, SnO₂, Sb₂O₃, Y₂O₃, TiO₂ and V₂O₅.

In one embodiment, the lithium compound has the general formula LiMₐN_{b}XO_{c}, wherein: M is a first-row transition metal including Fe, Mn, Ni, V, Co and Ti; N is a metal selected from the group Fe, Mn, Ni, V, Co, Ti, Mg, Ca, Cu, Nb, Zr and rare-earth metals; X is selected from elements P, Si, S, V and Ge; and a, b and c have respective values that would render said lithium compound charge-neutral. In another embodiment, the lithium compound has the general formula LiₐA_{1-y}B_{y}(XO₄)_{b}, wherein: A is a first-row transition metal including Fe, Mn, Ni, V, Co and Ti; B is a metal selected from the group Fe, Mn, Ni, V, Co, Ti, Mg, Ca, Cu, Nb, Zr and rare-earth metals; X is selected from elements P, Si, S, V and Ge; and 0<a≦1, 0<y≦0.5 and 0<b≦1.

A second embodiment of the invention calls for a mixed crystal compound with the general formula LiₐA_{1-y}B_{y}(XO₄)_{b}/M_{c}N_{d}, wherein: A is a first-row transition metal including Fe, Mn, Ni, V, Co and Ti; B is a metal selected from the group Fe, Mn, Ni, V, Co, Ti, Mg, Ca, Cu, Nb, Zr and rare-earth metals; X is selected from elements P, Si, S, V and Ge; M is metal selected from groups IA, IIA, IIIA, IVA, VA, IIIB, IVB and VB of the periodic table; N is selected from O, N, H, S, SO₄, PO₄, OH, Cl, F and C; and wherein 0<a≦1, 0<y≦0.5, 0<b≦1, 0<c≦4 and 0<d≦6.

A third embodiment of the invention discloses a cathode material for lithium secondary batteries that comprises at least one lithium iron phosphate compound and at least one metal compound, wherein the metal compound is distributed within the lithium iron phosphate compound to form a composite compound. In another embodiment, the metal compound is distributed within the lithium iron phosphate compound to form a mixed crystal. In one instance, the lithium iron phosphate compound and the metal compound are able to provide molar ratios of about 1 to 0.001-0.1. In another embodiment, the cathode material may include at least one carbon additive, the carbon additive capable of providing the cathode material with 1-15% of carbon by weight. The carbon additive includes one or more members selected from the group consisting of carbon black, acetylene black, graphite and carbohydrate compound.

A fourth embodiment discloses a cathode material for lithium secondary batteries that comprises at least one first crystalline compound and at least one second crystalline compound. The first crystalline compound is distributed within the second crystalline compound to form a composite compound that exhibits better electrical properties including better electrical conductance, capacitance and recyclability. The first crystalline compound can be prepared by heating a combination of at least one lithium source, at least one iron source, and at least one phosphate source while the second crystalline compound can be prepared by heating at least two metal compounds. The second crystalline compound can also include one or more members selected from groups IA, IIA, IIIA, IVA, VA, IIIB, IVB and VB of the periodic table.

In one embodiment, the lithium source, iron source, phosphate source and second crystalline compound are able to provide Li:Fe:P:second crystalline compound molar ratios of about 1:1:1:0.001-0.1. In other embodiments, various Li:Fe:P:second crystalline compound molar ratios may be adopted. The lithium source includes one or more members selected from the group consisting of lithium carbonate, lithium hydroxide, lithium oxalate, lithium acetate, lithium fluoride, lithium chloride, lithium bromide, lithium iodide and lithium dihydrogen phosphate. The iron source includes one or more members selected from the group consisting of ferrous oxalate, ferrous acetate, ferrous chloride, ferrous sulfate, iron phosphate, ferrous oxide, ferric oxide, iron oxide and ferric phosphate. And the phosphate source includes one or more members selected from the group consisting of ammonium, ammonium phosphate, ammonium dihydrogen phosphate, iron phosphate, ferric phosphate and lithium hydrogen phosphate.

A fifth embodiment of the present invention discloses a method of preparing a composite compound comprising: mixing a lithium compound and a metal oxide; heating the mixture to a first temperature to form a composite compound with enhanced electrical conductance. In one preferred embodiment, the composite compound has a mixed crystalline structure. In one particular example of the invention, the lithium compound is a metal intercalation compound that has the general formula LiMₐN_{b}XO_{c}, wherein M is a first-row transition metal including Fe, Mn, Ni, V, Co, and Ti; N is a metal selected from the group Fe, Mn, Ni, V, Co, Ti, Mg, Ca, Cu, Nb, Zr and rare-earth metals; X is selected from elements P, Si, S, V and Ge; and a, b and c have respective values that would render said metal intercalation compound charge-neutral. In another example, the metal oxide includes one or more members selected from groups IA, IIA, IIIA, IVA, VA, IIIB, IVB and VB of the period table. Specifically, the first and second metal oxides may include one or more members selected from the group consisting of MgO, SrO, A[₂0₃, SnO₂, Sb₂O₃, Y₂O₃, TiO₂ and V₂O₅.

In other instances, batteries may be manufactured using the cathode materials as described in the previously disclosed embodiments.

Other variations, embodiments and features of the present invention will become evident from the following detailed description, drawings and claims.

### BRIEF DESCRIPTION OF THE DRAWINGS

FIGS. 1-4 illustrate structural relationships of a mixed crystal, specifically, between a lithium iron phosphate compound and a composite metal compound; and

FIG. 5 illustrates an x-ray diffraction (XRD) pattern a of composite compound according to an embodiment of the presently disclosed invention.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

A cathode material for lithium secondary batteries can be provided by combining at least one lithium metal compound with at least one mixed metal crystal, wherein the lithium metal compound has an olivine structure and the mixed metal crystal includes a mixture of metal elements and metal oxides.

A general formula for a mixed crystal compound can be expressed as:

LiₐA_{1-y}B_{y}(XO₄)_{b}/M_{c}N_{d}, wherein:

A includes one or more transition metals from the first row including without limitation Fe, Mn, Ni, V, Co and Ti;

B includes one or more doped metals including without limitation Fe, Mn, Ni, V, Co, Ti, Mg, Ca, Cu, Nb, Zr and other rare earth elements or metals;

X includes one or more members of P, Si, S, V and Ge;

M includes one or more metals selected from groups IA, IIA, IIIA, IVA, VA, IIIB, IVB and VB of the periodic table;

N includes one or more members of O, N, H, S, SO₄, PO₄, OH, Cl and fluorine-related elements; and

0<a≦1, 0<y≦0.5, 0<b≦1, 0<c≦4 and 0<d≦6.

The mixed crystal compound includes a lithium compound [LiₐA_{1-y}B_{y}(XO₄)_{b}] portion and a metal compound M_{c}N_{d} portion having a mixed crystalline relationship, with the lithium compound serving as the backbone or main building block of the cathode material. In one instance, the metal compound can be distributed into the lithium compound to provide a composite compound or a mixed crystal.

The cathode material may also include doped carbon additives, e.g., the mixed crystal compound LiₐA_{1-y}B_{y}(XO₄)_{b}/M_{c}N_{d} may be doped with carbon additives scattered between grain boundaries or coated on the grain surfaces. The doped carbon additive may provide the final cathode material product with 1-15% of carbon by weight. In one embodiment, the carbon additive includes one or more members selected from the group consisting of carbon black, acetylene black, graphite and carbohydrate compound. In other embodiments, the carbon additive may include other carbon-related elements, precursors or compounds.

The microstructure of the mixed crystal compound, which is capable of being utilized as a cathode material, includes the lithium compound and the metal compound having a mixed-crystalline structure with mixed crystal lattices. The cathode material can come in at least three possible forms: smaller crystals residing within a larger crystal lattice, smaller crystal residing in between grain boundaries of large crystals, or smaller crystals residing on the exterior grain surfaces of a large crystal.

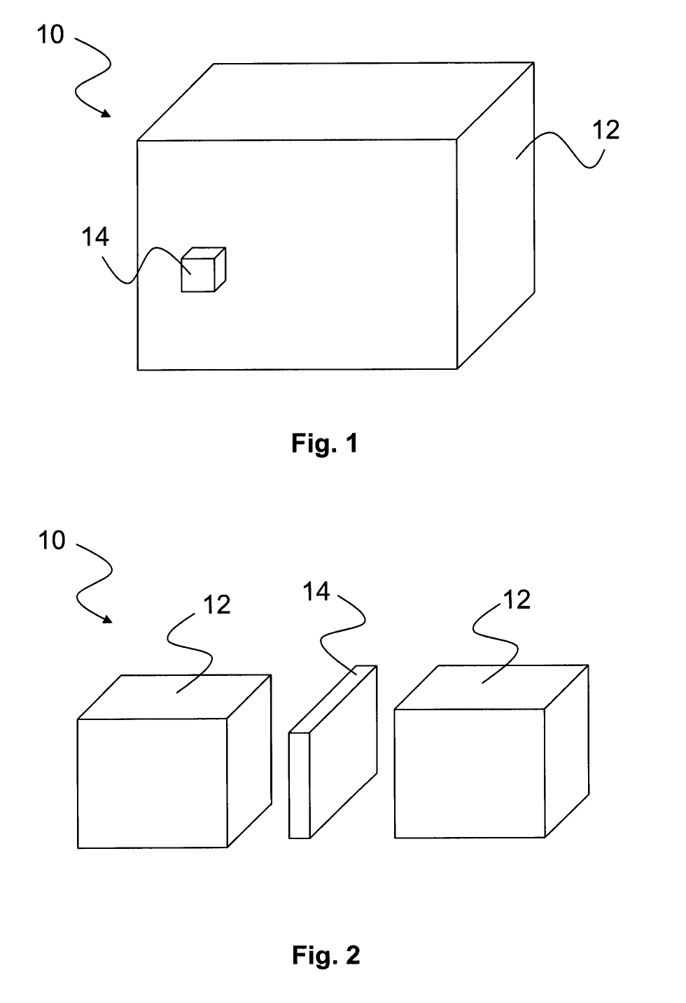

Reference is now made to FIGS. 1-4 illustrating a mixed crystal 10 having the chemical formula LiₐA_{1-y}B_{y}(XO₄)_{b}/M_{c}N_{d} according to an embodiment of the presently disclosed invention. Specifically, the mixed crystal 10 includes a mixture of a lithium compound [LiₐA_{1-y}B_{y}(XO₄)_{b}] 12 and a mixed metal crystal or metal compound [M_{c}N_{d}] 14. The lithium compound 12 has a larger crystal lattice while the metal compound 14 has a smaller crystal lattice.

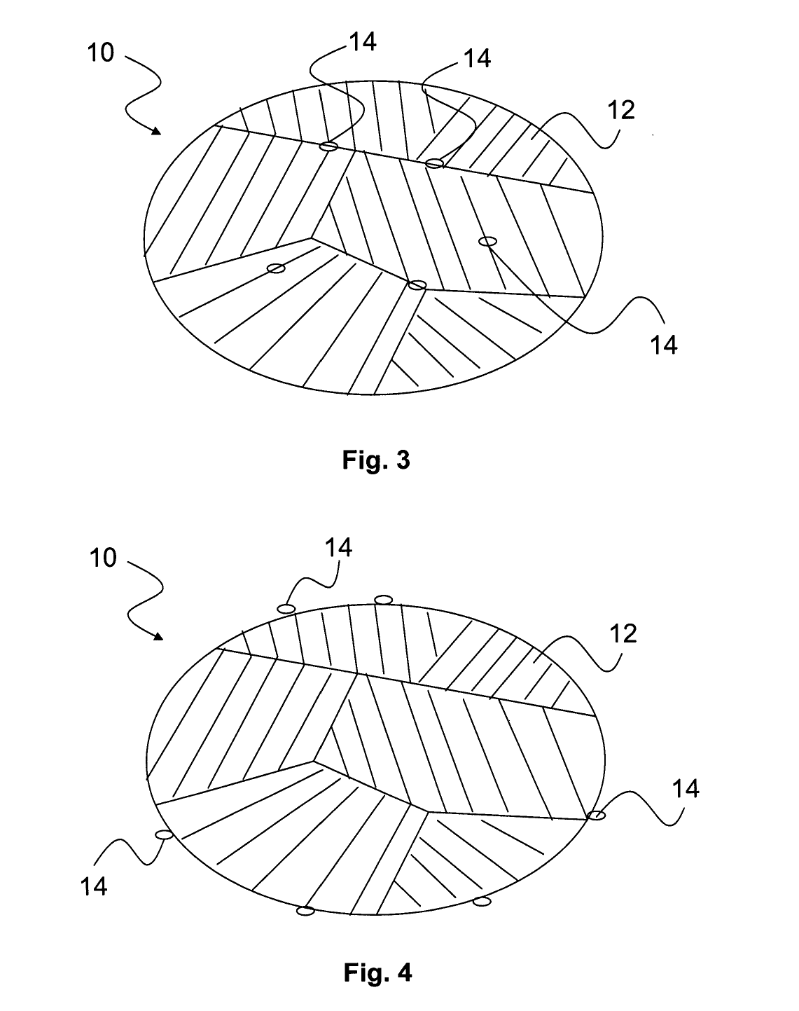

In one instance, the metal compound 14, having a smaller crystal lattice 14, may be received or distributed within the lithium compound 12 having the larger crystal lattice 12 as best illustrated in FIG. 1. In another instance, the metal compound 14 can be received or distributed between two or more large crystal lattices 12 as best illustrated in FIG. 2. Alternatively, the metal compound 14 can reside within grain boundaries of the lithium compound 12 as best illustrated in FIG. 3. Lastly, the metal compound 14 may be dispersed about the exterior grain surfaces of the lithium compound 12 as best illustrated in FIG. 4. In all of these instances, lithium ion migration serves as a bridge either within a crystal lattice or in between two or more crystal lattices, wherein lithium ions can be fully released for enhanced electrical properties including electrical conductance, capacitance and recyclability. The mixed crystal may also provide enhanced electrochemical properties.

In other embodiments, the mixed crystal 10 may take on mixed crystalline forms. In other words, during formation of the metal compound 14 by mixing at least two metal oxides, a large number of crystal defects may be introduced within the intermediary or composite crystals such that the electronic states and formation of the metal oxides are altered or changed. The metal compound 14 with its mixed crystalline structure, therefore, contains a large number of oxygen vacancies and missing oxygen atoms. The oxygen vacancies can facilitate carrier conduction thereby enhancing the conductivity of the mixed crystal 10. The formation of the metal compound 14 having two or more metal oxides will become more apparent in subsequent discussion.

In some embodiments, the metal compound 14 can be received between the grain boundaries or on the exterior crystal lattices of the lithium compound 12 in forming the mixed crystal 10 as described above. In the alternative, the metal compound 14 and the lithium compound 12 may be heated or sintered at about 600-900 ° C in an inert gas or reducing gas atmosphere for at least 2 hours. The resulting mixed crystal 10 provides an enhanced active material with improved electrical properties including conductivity and electrochemical properties thereby enhancing conductivity and charging capacity of a lithium secondary battery.

In one embodiment, the lithium compound has the general formula LiMₐN_{b}XO_{c}, wherein: M is a first-row transition metal including Fe, Mn, Ni, V, Co and Ti; N is a metal selected from the group Fe, Mn, Ni, V, Co, Ti, Mg, Ca, Cu, Nb, Zr and rare-earth metals; X is selected from elements P, Si, S, V and Ge; and a, b and c have respective values that would render said lithium compound charge-neutral. The lithium compound can include a metal intercalation compound having a similar general formula. In other embodiments, the lithium compound has the general formula LiₐA_{1-y}B_{y}(XO₄)_{b}, wherein: A is a first-row transition metal including Fe, Mn, Ni, V, Co and Ti; B is a metal selected from the group Fe, Mn, Ni, V, Co, Ti, Mg, Ca, Cu, Nb, Zr and rare-earth metals; X is selected from elements P, Si, S, V and Ge; and 0<a≦1, 0≦y≦0.5 and 0<b≦1. In yet another embodiment, the metal compound has the general formula M_{c}N_{d}, wherein M is metal selected from IA, IIA, IIIA, IVA, VA, IIIB, IVB and VB groups in the periodic table; N is selected from O, N, H, S, SO₄, PO₄, OH, Cl, F, and C; and 0<c≦4 and 0<d≦6.

In another embodiment, a cathode material for lithium secondary batteries can be provided by sintering lithium iron phosphate (LiFePO₄) with a mixture compound, the cathode material capable of providing LiFePO₄: mixture compound molar ratios of 1:0.001-0.1. In this embodiment, the mixture compound can be formed of two or more metal oxides wherein the metal can be selected from groups IA, IIA, IIIA, IVA, VA, IIIB, IVB and VB of the periodic table. In another embodiment, the weight of a first metal oxide is about 0.5-20% of the weight of a second metal oxide.

The mixture of metal oxides can take on a mixed crystal configuration. Based on mixed crystal formation theory, mixing of two or more metal oxides can form a composite mixed metal crystal such that a plurality of crystal defects are introduced to the crystal structure and lattice. The electronic states of the metal oxides are altered or changed thereby producing a large number of oxygen atom vacancies. These vacancies facilitate electronic carrier conductions thus producing a highly conductive mixed metal crystal.

The metal mixture compound, having a mixed crystalline configuration, can be coupled to the crystal lattices of LiFePO₄ by a heating or sintering process. Alternatively, after the metal oxides have been heated and the mixed metal crystal has been formed, the mixed metal crystal can be coupled to the crystal lattices of LiFePO₄ to provide a lithium iron phosphate cathode material with a mixed crystal structure and configuration. The resulting mixed crystal structure can effectively improve the conductivity, electrochemical properties, and greatly enhance the charge capacity of the lithium secondary battery.

In other embodiments, the lithium iron phosphate cathode material can further include carbon coating on the exterior surfaces of the sintered product, the amount of carbon material added being capable of providing the final product with 1-15% of carbon by weight. The types of carbon material that can be utilized include without limitation one or more of carbon black, acetylene black, graphite and carbohydrate compound.

The invention also includes batteries made from the new cathode materials described in other embodiments.

A method of preparing a mixed crystal lithium iron phosphate cathode material includes evenly mixing at least one LiFePO₄ compound with a mixture compound and heating the resulting mixture to 600-900° C. in an inert gas or reducing gas atmosphere for between 2-48 hours. The mixture compound includes two or more metal oxides wherein the metal can be selected from groups IA, IIA, IIIA, IVA, VA, IIIB, IVB and VB of the periodic table. The mixture compound provides a mixed crystalline structure, wherein a method of preparing the mixture compound with the corresponding mixed crystalline structure includes mixing metal oxides from groups IA, IIA, IIIA, IVA, VA, IIIB, IVB and VB, and heating the mixture to 600-1200° C. for between 2-48 hours.

The LiFePO₄ compound may be prepared by providing lithium, iron and phosphate sources to provide Li, Fe and P atoms with Li:Fe:P molar ratios of 1:1:1. In other embodiments, different Li:Fe:P molar ratios may be adopted. The mixture can accordingly be grinded in a ball mill for 2-48 hours, dried between 40-80° C. or stirred until dry, and heated to 600-900° C. in an inert gas or reducing gas atmosphere for between 2-48 hours.

After combining the LiFePO₄ compound with the mixture compound having mixed crystalline structure, carbon additives can be provided to the resulting mixture and sintered to facilitate carbon coating. The amount of carbon additives is capable of providing the resulting lithium iron phosphate cathode material with 1-15% of carbon by weight. The types of carbon material that can be utilized include without limitation one or more of carbon black, acetylene black, graphite and carbohydrate compound. The carbon coating process further enhances the electrical conductivity of the cathode material.

Another method of preparing a mixed crystal cathode material includes evenly mixing lithium, iron and phosphate sources and heat to 600-900° C. in an inert gas or reducing gas atmosphere for at least 2 hours. The resulting mixture can then be combined with a mixed metal compound having a combination of two or more metal oxides selected from groups IA, IIA, IIIA, IVA, VA, IIIB, IVB and VB of the periodic table. In one embodiment, the lithium source, iron source, phosphate source and mixed metal compound are capable of providing Li:Fe:P:mixed metal compound molar ratios of 1:1:1:0.001-0.1. In other embodiments, different Li:Fe:P:mixed metal compound molar ratios may be adopted. Furthermore, at least one carbon source can be added to the resulting mixture, the carbon source including one or more of the following without limitation: carbon black, acetylene black, graphite and carbohydrate compound. The amount of carbon source added to the resulting mixture should be able to provide the final product with 1-15% of carbon by weight.

According to the presently disclosed embodiments, lithium sources capable of being used in preparing the cathode material include one or more of the following compounds without limitation: lithium carbonate, lithium hydroxide, lithium oxalate, lithium acetate, lithium fluoride, lithium chloride, lithium bromide, lithium iodide and lithium dihydrogen phosphate. Likewise, iron sources include one or more of the following compounds without limitation: ferrous oxalate, ferrous acetate, ferrous chloride, ferrous sulfate, iron phosphate, ferrous oxide, ferric oxide, iron oxide and ferric phosphate. When using a trivalent iron compound as a source of iron, the ball milling process requires adding a carbon source to reduce the trivalent iron to a divalent iron. Furthermore, phosphorous sources include one or more of the following compounds without limitation: ammonium, ammonium phosphate, ammonium dihydrogen phosphate, iron phosphate, ferric phosphate and lithium hydrogen phosphate.

During the mixing process, specifically grinding in a ball mill, one or more solvents may be introduced including ethanol, DI water and acetone. In other embodiments, other mixing media and solvents may be utilized. In addition, the mixture can be dried between 40-80° C. or stirred until dry.

The types of inert gases that may be utilized include helium, neon, argon, krypton, xenon, radon and nitrogen. Additionally, reducing gases including hydrogen and carbon monoxide can also be incorporated. Other suitable gases may also be adopted.

It is understood that other lithium, iron, phosphorous and carbon sources may be utilized along with suitable solvents, inert gases and reducing gases as will be appreciated by one skilled in the art.

It is understood that the new cathode materials described above can be used to make lithium secondary batteries and other types of batteries.

The following are various embodiments of the mixed-crystal lithium iron phosphate cathode materials according to the presently disclosed invention.

### EXAMPLE 1

Mix LiFePO₄ with [Y₂O₃ and Sb₂O₃ (mass ratio 0.2:1)] to provide [LiFePO₄ (Y₂O₃ and Sb₂O₃)] molar ratio of [1:(0.04)], add carbon-containing acetylene black (amount of carbon capable of providing 10% by weight of carbon content in the final product), grind the mixture in a ball mill for 15 hours, remove and dry at 60° C. Heat the resulting powder in a nitrogen atmosphere at 650° C. for 5 hours to provide a LiFePO₄ composite cathode material.

### EXAMPLE 2

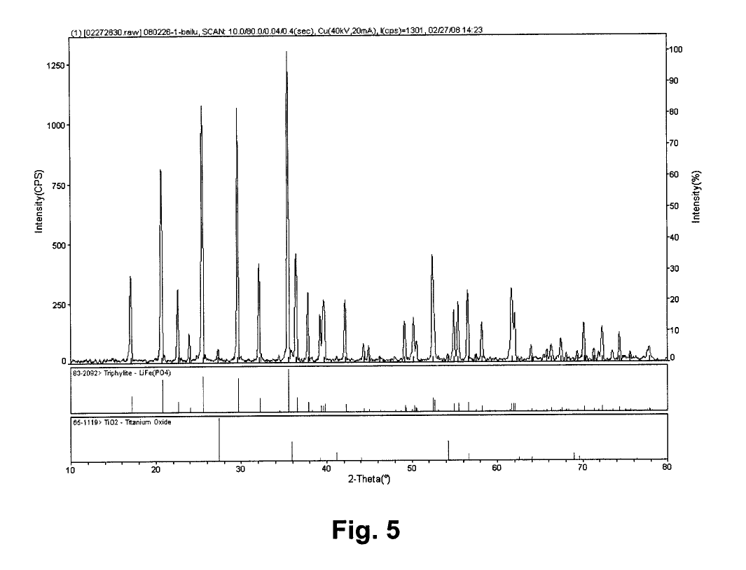

Mix Sb₂O₃ and TiO₂ (mass ratio 0.15:1), grind the mixture in a ball mill for 5 hours, remove and dry at 60° C. Heat the resulting powder at 1000° C. for 8 hours to provide a Sb₂O₃ and TiO₂ mixed compound. Under x-ray diffraction (XRD), the mixed compound did not exhibit new characteristic peaks on the XRD pattern indicating that the two oxides did not generate a new oxide compound. See FIG. 5 & 6. The mixed compound, therefore, remained in a mixed crystal state indicative of a mixed crystal structure.

Mix LiFePO₄ with the mixed crystal to provide a molar ratio of 1 to 0.02, add carbon-containing glucose (amount of carbon capable of providing 8% by weight of carbon content in the final product), grind the mixture in a ball mill for 20 hours, remove and dry at 60° C. Heat the resulting powder in a nitrogen atmosphere at 750° C. for 8 hours to provide a LiFePO₄ composite cathode material.

### EXAMPLE 3

Mix lithium fluoride, iron phosphate and diammonium phosphate to provide Li:Fe:P atomic ratio of 1.02:1:1, grind the mixture in a ball mill for 20 hours, remove and dry at 65° C. Heat the resulting powder in a nitrogen atmosphere at 750° C. for 12 hours to provide LiFePO₄.

Mix V₂O₅ and TiO₂ (mass ratio 0.08:1), grind the mixture in a ball mill for 8 hours, remove and dry at 65° C. Heat the resulting powder at 500° C. for 8 hours to provide a V₂O₅ and TiO₂ mixed compound. Under x-ray diffraction (XRD), the mixed compound did not exhibit new characteristic peaks on the XRD pattern indicating that the two oxides did not generate a new oxide compound. The mixed compound, therefore, remained in a mixed crystal state indicative of a mixed crystal structure.

Mix LiFePO₄ with the mixed crystal to provide a molar ratio of 1 to 0.05, grind the mixture in a ball mill for 10 hours, remove and dry at 60° C. Heat the resulting powder in a nitrogen atmosphere at 750° C. for 8 hours to provide a LiFePO₄ composite cathode material.

### EXAMPLE 4

Mix MgO and Al₂O₃ (mass ratio 0.05:1), grind the mixture in a ball mill for 6 hours, remove and dry at 60° C. Heat the resulting powder to 1000° C. for 6 hours to provide a MgO and Al₂O₃ mixed compound. Under x-ray diffraction (XRD), the mixed compound did not exhibit new characteristic peaks on the XRD pattern indicating that the two oxides did not generate a new oxide compound. The mixed compound, therefore, remained in a mixed crystal state indicative of a mixed crystal structure.

Mix LiFePO₄ with the mixed crystal to provide a molar ratio of 1 to 0.002, add carbon-containing graphite (amount of carbon capable of providing 15% by weight of carbon content in the final product), grind the mixture in a ball mill for 15 hours, remove and dry at 65° C. Heat the resulting powder in a nitrogen atmosphere at 700° C. for 10 hours to provide a LiFePO₄ composite cathode material.

### EXAMPLE 5

Mix lithium carbonate, ferric oxide, diammonium phosphate, SnO₂ and Nb₂O₅ to provide Li:Fe:P:(SnO₂ and Nb₂O₅) molar ratio of 1.01:1:1:0.04, wherein SnO₂ is 5% of Nb₂O₅ by mass and may be added at the same time to bring about reduction of the ferric oxide along with carbon-containing acetylene black (amount of carbon capable of providing 5% by weight of carbon content in the final product), grind the mixture in a ball mill for 24 hours, and stir at 65° C. until dry. Heat the resulting powder in a nitrogen atmosphere at 750° C. for 20 hours to provide a LiFePO₄ composite cathode material.

### EXAMPLE 6

Mix lithium carbonate, ferrous oxalate, diammonium phosphate, SnO₂ and TiO₂ to provide Li:Fe:P:(SnO₂ and TiO₂) molar ratio of 1.02:1:1:0.03, wherein SnO₂ is 15% of TiO₂ by mass, carbon-containing sucrose (amount of carbon capable of providing 7% by weight of carbon content in the final product), grind the mixture in a ball mill for 20 hours, remove and dry at 65° C. Heat the resulting powder in a nitrogen atmosphere at 750° C. for 18 hours to provide a LiFePO₄ composite cathode material.

### EXAMPLE 7

Mix lithium carbonate, ferrous phosphate, Nb₂O₅ and TiO₂ to provide Li:Fe:P:(Nb₂O₅ and TiO₂) molar ratio of 1:1:1:0.01, wherein Nb₂O₅ is 5% of TiO₂ by mass, carbon-containing sucrose (amount of carbon capable of providing 5% by weight of carbon content in the final product), grind the mixture in a ball mill for 20 hours, remove and dry at 65° C. Heat the resulting powder in a nitrogen atmosphere at 750° C. for 15 hours to provide a LiFePO₄ composite cathode material.

### REFERENCE 1

Mix lithium carbonate, ferrous oxalate, copper fluoride and diammonium phosphate to provide a molar ratio of 1:0.9:0.1:1, add carbon-containing sucrose (amount of carbon capable of providing 7% by weight of carbon content in the final product), grind the mixture in a ball mill for 10 hours, remove and dry at 70° C. Heat the resulting powder in a nitrogen atmosphere at 650° C. for 20 hours to provide a LiFePO₄ composite cathode material.

### TESTING OF EXAMPLES 1-7 AND REFERENCE 1

(1) Battery Preparation

(a) Cathode Active Material

Separately combine 100 grams of each of the LiFePO₄ composite material from examples 1-6 and reference 1 with 3 grams of polyvinylidene fluoride (PVDF) binder and 2 grams of acetylene black to 50 grams of N-methylpyrrolidone (NMP), mix in a vacuum mixer into a uniform slurry, apply a coating of about 20 microns thick to each side of an aluminum foil, dry at 150° C., roll and crop to a size of 480×44 mm² to provide about 2.8 grams of cathode active material.

(b) Anode Active Material

Combine 100 grams of natural graphite with 3 grams of polyvinylidene fluoride (PVDF) binder and 3 grams of conductive acetylene black to 100 grams of N-methylpyrrolidone (NMP), mix in a vacuum mixer into a uniform slurry, apply a coating of about 12 microns thick to each side of a copper foil, dry at 90° C., roll and crop to a size of 485×45 mm² to provide about 2.6 grams of anode active material.

(c) Battery Assembly

Separately wind each of the cathode and anode active materials with polypropylene film into a lithium secondary battery core, followed by dissolving one mole of LiPF₆ in a mixture of non-aqueous electrolyte solvent EC/EMC/DEC to provide a ratio of 1:1:1, inject and seal the electrolyte having a capacity of 3.8 g/Ah into the battery to provide separate lithium secondary batteries for testing.

(2) Specific Discharge Capacity Test

Using a current charge of 0.2 C, charge each battery for 4 hours, and then at constant voltage to 3.8 V. After setting the battery aside for 20 minutes, using a current of 0.2 C discharge from 3.8 V to 3.0 V, record the battery's initial discharge capacity, and use the following equation to calculate the battery's initial specific capacity:

Initial specific capacity=Initial discharge capacity (milliampere hour)/weight of cathode active material (grams).

(3) Measure the Specific Capacity After 500 Cycles

(4) Separately Measure Specific Cat 1 C, 3 C and 5 C

The testing cycle results for examples 1-7 and reference 1 are shown in Table 1.

TABLE 1
Test results of LiFePO₄ composite cathode materials and reference sample.

| | Ex. 1 | Ex. 2 | Ex. 3 | Ex. 4 | Ex. 5 | Ex. 6 | Ex. 7 | Ref. 1 |
|---|---|---|---|---|---|---|---|---|
| Initial specific capacity (mAh/g) | 130 | 125 | 126 | 125 | 128 | 131 | 131 | 98 |
| Specific capacity after 500 cycles (mAh/g) | 128 | 124 | 124 | 123 | 126 | 130 | 128 | 62 |
| Specific capacity at 1 C mAh/g) | 126 | 120 | 120 | 121 | 122 | 126 | 124 | 80 |
| Specific capacity at 3 C (mAh/g) | 111 | 107 | 107 | 106 | 109 | 112 | 116 | 50 |
| Specific capacity at 5 C (mAh/g) | 108 | 105 | 106 | 105 | 106 | 109 | 109 | 34 |

From the data in Table 1, it can be observed that the LiFePO₄ composite cathode materials according to examples 1-7 of the presently disclosed invention provide higher initial specific discharge capacity than reference 1. Accordingly, the LiFePO₄ composite cathode materials for lithium secondary batteries and methods of manufacturing such according to the presently disclosed embodiments provide superior electrical performance, e.g., higher discharge capacity, low capacity loss after multiple cycles, and high discharge capacity retention rate.

Additional experimental data are provided in Tables 2 and 3 illustrating the electrical properties of some of the examples described above.

TABLE 2

| | | | | Middle | | Specific |
|---|---|---|---|---|---|---|
| | Charging | Discharging | | discharge | | capacity |
| | capacity | capacity | Efficiency | voltage | Set capacity | (mAh/g) |
| Example 1 | 11.16 | 9.91 | 88.8% | 3.372 | 9.60 | 154.86 |
| Example 3 | 10.89 | 10.02 | 91.9% | 3.371 | 9.74 | 156.48 |
| Example 4 | 11.22 | 10.18 | 90.7% | 3.376 | 9.88 | 159.09 |
| Example 5 | 10.84 | 10.01 | 92.3% | 3.375 | 9.74 | 156.34 |
| Minimum | 10.84 | 9.91 | 88.8% | 3.37 | 9.60 | 154.86 |
| Average | 11.03 | 10.03 | 90.9% | 3.37 | 9.74 | 156.70 |
| Maximum | 11.22 | 10.18 | 92.3% | 3.38 | 9.88 | 159.09 |
| Range | 0.38 | 0.27 | 3.5% | 0.00 | 0.28 | 4.23 |
| Median | 11.03 | 10.01 | 91.3% | 3.37 | 9.74 | 156.41 |
| STDEV | 0.19 | 0.11 | 1.6% | 0.00 | 0.12 | 1.76 |

TABLE 3

| | | | | Middle | | Specific |
|---|---|---|---|---|---|---|
| | Charging | Discharging | | discharge | | capacity |
| | capacity | capacity | Efficiency | voltage | Set capacity | (mAh/g) |
| Example 1 | 11.33 | 10.20 | 90.0% | 3.343 | 9.67 | 159.38 |
| Example 2 | 10.16 | 9.19 | 90.5% | 3.362 | 8.75 | 143.66 |
| Example 4 | 11.19 | 10.18 | 90.9% | 3.367 | 9.67 | 159.06 |
| Example 5 | 11.21 | 10.20 | 91.0% | 3.350 | 9.67 | 159.36 |
| Minimum | 10.16 | 9.19 | 90.0% | 3.34 | 8.75 | 143.66 |
| Average | 10.97 | 9.94 | 90.6% | 3.36 | 9.44 | 155.36 |
| Maximum | 11.33 | 10.20 | 91.0% | 3.37 | 9.67 | 159.38 |
| Range | 1.17 | 1.01 | 1.0% | 0.02 | 0.92 | 15.72 |
| Median | 11.20 | 10.19 | 90.7% | 3.36 | 9.67 | 159.21 |
| STDEV | 0.55 | 0.50 | 0.4% | 0.01 | 0.46 | 7.81 |

Reference is now made to FIG. 5 illustrating an x-ray diffraction (XRD) pattern of a cathode composite compound according to example 7. As shown in the figure, the TiO₂ peak from the starting material is missing after formation of the cathode composite compound, which is suggestive of a substance having mixed crystalline structure or a mixed crystal compound. It is also possible that the TiO₂ exchange has taken place with Fe atoms. However, it is suspected that a mixed crystal is the most likely outcome.

Although the invention has been described in detail with reference to several embodiments, additional variations and modifications exist within the scope and spirit of the invention as described and defined in the following claims.

What is claimed is:

1. A mixed crystal compound with the general formula LiₐA_{1-y}B_{y}(XO₄)_{b}/M_{c}N_{d}, wherein:
A is a first-row transition metal including Fe, Mn, Ni, V, Co and Ti;
B is a metal selected from the group Fe, Mn, Ni, V, Co, Ti, Mg, Ca, Cu, Nb, Zr and rare-earth metals;
X is selected from elements P, Si, S, V and Ge;
M is metal selected from groups IA, IIA, IIIA, IVA, VA, IIIB, IVB and VB of the periodic table;
N is selected from O, N, H, S, SO₄, PO₄, OH, Cl and F; and
0<a≦1, 0≦y≦0.5, 0<b≦1, 0<c≦4 and 0<d≦6.

2. A substance comprising:
at least one lithium compound; and
at least one metal compound, wherein said metal compound is distributed into said lithium compound to form a composite compound with enhanced electrical properties.

3. The substance of claim 2, wherein said lithium compound has the general formula LiMₐN_{b}XO_{c}, wherein:
M is a first-row transition metal including Fe, Mn, Ni, V, Co and Ti;
N is a metal selected from the group Fe, Mn, Ni, V, Co, Ti, Mg, Ca, Cu, Nb, Zr and rare-earth metals;
X is selected from elements P, Si, S, V and Ge; and
a, b and c have respective values that would render said lithium compound charge-neutral.

4. The substance of claim 2, wherein said lithium compound has the general formula LiₐA_{1-y}B_{y}(XO₄)_{b}, wherein:
A is a first-row transition metal including Fe, Mn, Ni, V, Co and Ti;
B is a metal selected from the group Fe, Mn, Ni, V, Co, Ti, Mg, Ca, Cu, Nb, Zr and rare-earth metals;
X is selected from elements P, Si, S, V and Ge; and
0<a≦1, 0≦y≦0.5 and 0<b≦1.

5. The substance of claim 2, wherein said metal compound has the general formula M_{c}N_{d}, wherein:
M is metal selected from IA, IIA, IIIA, IVA, VA, IIIB, IVB and VB groups in the periodic table;
N is selected from O, N, H, S, SO₄, PO₄, OH, Cl and F; and
0<c≦4 and 0<d≦6.

6. The substance of claim 2, wherein said lithium compound is a metal intercalation compound.

7. The substance of claim 6, wherein said metal intercalation compound has the general formula LiMₐN_{b}XO_{c}, wherein:
M is a first-row transition metal including Fe, Mn, Ni, V, Co and Ti;
N is a metal selected from the group Fe, Mn, Ni, V, Co, Ti, Mg, Ca, Cu, Nb, Zr and rare-earth metals;
X is selected from elements P, Si, S, V and Ge; and
a, b and c have respective values that would render said metal intercalation compound charge-neutral.

8. A substance comprising:
at least one lithium compound; and
at least one metal compound, wherein said metal compound is distributed into said lithium compound to form a composite compound with a mixed crystalline structure.

9. The substance of claim 8, wherein said lithium compound has the general formula LiMₐN_{b}XO_{c}, wherein:
M is a first-row transition metal including Fe, Mn, Ni, V, Co and Ti;
N is a metal selected from the group Fe, Mn, Ni, V, Co, Ti, Mg, Ca, Cu, Nb, Zr and rare-earth metals;
X is selected from elements P, Si, S, V and Ge; and
a, b and c have respective values that would render said lithium compound charge-neutral.

10. The substance of claim 8, wherein said lithium compound has the general formula LiₐA_{1-y}B_{y}(XO₄)_{b}, wherein:
A is a first-row transition metal including Fe, Mn, Ni, V, Co and Ti;
B is a metal selected from the group Fe, Mn, Ni, V, Co, Ti, Mg, Ca, Cu, Nb, Zr and rare-earth metals;
X is selected from elements P, Si, S, V and Ge; and
0<a≦1, 0≦y≦0.5 and 0<b≦1.

11. The substance of claim 8, wherein said metal compound has the general formula M_{c}N_{d}, wherein:
M is metal selected from IA, IIA, IIIA, IVA, VA, IIIB, IVB and VB groups in the periodic table;
N is selected from O, N, H, S, SO₄, PO₄, OH, Cl and F; and
0<c≦4 and 0<d≦6.

12. The substance of claim 8, wherein said lithium compound is a metal intercalation compound.

13. The substance of claim 12, wherein said metal intercalation compound has the general formula LiMₐN_{b}XO_{c}, wherein:
M is a first-row transition metal including Fe, Mn, Ni, V, Co and Ti;
N is a metal selected from the group Fe, Mn, Ni, V, Co, Ti, Mg, Ca, Cu, Nb, Zr and rare-earth metals;
X is selected from elements P, Si, S, V and Ge; and
a, b and c have respective values that would render said metal intercalation compound charge-neutral.

14. A cathode material for lithium secondary batteries comprising:
at least one lithium iron phosphate compound; and
at least one metal compound, wherein said metal compound is distributed within said lithium iron phosphate compound to form a composite compound.

15. The material of claim 14, wherein said metal compound has the general formula M_{c}N_{d}, wherein:
M is metal selected from IA, IIA, IIIA, IVA, VA, IIIB, IVB and VB groups in the periodic table;
N is selected from O, N, H, S, SO₄, PO₄, OH, Cl and F; and
0<c≦4 and 0<d≦6.

16. The material of claim 14, wherein said lithium iron phosphate compound and said metal compound has molar ratios of about 1 to 0.001-0.1.

17. The material of claim 14, further comprising a carbon additive.

18. The material of claim 17, said carbon additive being capable of providing said cathode material with 1-15% of carbon by weight.

19. The material of claim 17, wherein said carbon additive includes one or more members selected from the group consisting of carbon black, acetylene black, graphite and carbohydrate compound.

20. A cathode material for lithium secondary batteries comprising:
at least one lithium iron phosphate compound; and
at least one metal compound, wherein said metal compound is distributed within said lithium iron phosphate compound to form a mixed crystal.

21. The material of claim 20, wherein said metal compound has the general formula M_{c}N_{d}, wherein:
M is metal selected from IA, IIA, IIIA, IVA, VA, IIIB, IVB and VB groups in the periodic table;
N is selected from O, N, H, S, SO₄, PO₄, OH, Cl and F; and
0<c≦4 and 0<d≦6.

22. The material of claim 20, wherein said lithium iron phosphate compound and said metal compound has molar ratios of about 1 to 0.001-0.1.

23. The material of claim 20, further comprising a carbon additive.

24. The material of claim 23, said carbon additive being capable of providing said cathode material with 1-15% of carbon by weight.

25. The material of claim 23, wherein said carbon additive includes one or more members selected from the group consisting of carbon black, acetylene black, graphite and carbohydrate compound.

26. A cathode material for lithium secondary batteries comprising:
at least one first crystalline compound, said first crystalline compound prepared by heating a combination of at least one lithium source, at least one iron source and at least one phosphate source; and
at least one second crystalline compound, wherein said second crystalline compound is distributed within said first crystalline compound to form a composite compound that exhibits enhanced electrical properties.

27. The material of claim 26, wherein said lithium source, iron source, phosphate source and said second crystalline compound provide Li:Fe:P:second crystalline compound molar ratios of about 1:1:1:0.001-0.1.

28. The material of claim 26, wherein said second crystalline compound includes one or more members selected from groups IA, IIA, IIIA, IVA, VA, IIIB, IVB and VB of the period table.

29. The material of claim 26, wherein said lithium source includes one or more members selected from the group consisting of lithium carbonate, lithium hydroxide, lithium oxalate, lithium acetate, lithium fluoride, lithium chloride, lithium bromide, lithium iodide and lithium dihydrogen phosphate; said iron source includes one or more members selected from the group consisting of ferrous oxalate, ferrous acetate, ferrous chloride, ferrous sulfate, iron phosphate, ferrous oxide, ferric oxide, iron oxide and ferric phosphate; and said phosphate source includes one or more members selected from the group consisting of ammonium, ammonium phosphate, ammonium dihydrogen phosphate, iron phosphate, ferric phosphate and lithium hydrogen phosphate.

30. The material of claim 26, further comprising a carbon additive.

31. The material of claim 30, wherein said carbon additive is capable of providing said cathode material with 1-15% of carbon by weight.

32. The material of claim 30, wherein said carbon additive includes one or more members selected from the group consisting of carbon black, acetylene black, graphite and carbohydrate compound.

33. A cathode material for lithium secondary batteries comprising:
at least one first crystalline compound, said first crystalline compound prepared by heating a combination of at least one lithium source, at least one iron source and at least one phosphate source; and
at least one second crystalline compound, wherein said second crystalline compound is distributed within said first crystalline compound to form a mixed crystal.

34. The material of claim 33, wherein said lithium source, iron source, phosphate source and said second crystalline compound provide Li:Fe:P:second crystalline compound molar ratios of about 1:1:1:0.001-0.1.

35. The material of claim 33, wherein said second crystalline compound includes one or more members selected from groups IA, IIA, IIIA, IVA, VA, IIIB, IVB and VB of the period table.

36. The material of claim 33, wherein said lithium source includes one or more members selected from the group consisting of lithium carbonate, lithium hydroxide, lithium oxalate, lithium acetate, lithium fluoride, lithium chloride, lithium bromide, lithium iodide and lithium dihydrogen phosphate; said iron source includes one or more members selected from the group consisting of ferrous oxalate, ferrous acetate, ferrous chloride, ferrous sulfate, iron phosphate, ferrous oxide, ferric oxide, iron oxide and ferric phosphate; and said phosphate source includes one or more members selected from the group consisting of ammonium, ammonium phosphate, ammonium dihydrogen phosphate, iron phosphate, ferric phosphate and lithium hydrogen phosphate.

37. The material of claim 33, further comprising a carbon additive.

38. The material of claim 37, wherein said carbon additive is capable of providing said cathode material with 1-15% of carbon by weight.

39. The material of claim 37, wherein said carbon additive includes one or more members selected from the group consisting of carbon black, acetylene black, graphite and carbohydrate compound.

40. A cathode material for lithium secondary batteries comprising:
at least one lithium iron phosphate compound;
at least one metal compound, wherein said metal compound is distributed within said lithium iron phosphate compound to form a composite compound; and
at least one carbon additive, said carbon additive capable of enhancing the electrical properties of the cathode material.

41. The material of claim 40, wherein said metal compound has the general formula M_{c}N_{d}, wherein:
M is metal selected from IA, IIA, IIIA, IVA, VA, IIIB, IVB and VB groups in the periodic table;
N is selected from O, N, H, S, SO₄, PO₄, OH, Cl and F; and
0<c≦4 and 0<d≦6.

42. The material of claim 40, wherein said lithium iron phosphate compound and said metal compound has molar ratios of about 1 to 0.001-0.1.

43. The material of claim 40, wherein said carbon additive includes one or more members selected from the group consisting of carbon black, acetylene black, graphite and carbohydrate compound.

44. The material of claim 40, wherein said carbon additive is capable of providing said cathode material with 1-15% of carbon by weight.

45. A cathode material for lithium secondary batteries comprising:
at least one lithium iron phosphate compound;
at least one metal compound, wherein said metal compound is distributed within said lithium iron phosphate compound to form a mixed crystal; and
at least one carbon additive, said carbon additive capable of enhancing the electrical properties of said cathode material.

46. The material of claim 45, wherein said metal compound has the general formula M_{c}N_{d}, wherein:
M is metal selected from IA, IIA, IIIA, IVA, VA, IIIB, IVB and VB groups in the periodic table;
N is selected from O, N, H, S, SO₄, PO₄, OH, Cl and F; and
0<c≦4 and 0<d≦6.

47. The material of claim 45, wherein said lithium iron phosphate compound and said metal compound has molar ratios of about 1 to 0.001-0.1.

48. The material of claim 45, wherein said carbon additive includes one or more members selected from the group consisting of carbon black, acetylene black, graphite and carbohydrate compound.

49. The material of claim 45, wherein said carbon additive is capable of providing said cathode material with 1-15% of carbon by weight.

50. A battery comprising a cathode, an anode and an electrolyte, said cathode further comprising the mixed crystal compound of claim 1.

51. A battery comprising a cathode, an anode and an electrolyte, said cathode further comprising the substance of claim 2.

52. A battery comprising a cathode, an anode and an electrolyte, said cathode further comprising the material of claim 8.

53. A battery comprising a cathode, an anode and an electrolyte, said cathode further comprising the material of claim 14.

54. A battery comprising a cathode, an anode and an electrolyte, said cathode further comprising the material of claim 20.

55. A battery comprising a cathode, an anode and an electrolyte, said cathode further comprising the material of claim 26.

56. A battery comprising a cathode, an anode and an electrolyte, said cathode further comprising the material of claim 33.

57. A battery comprising a cathode, an anode and an electrolyte, said cathode further comprising the material of claim 40.

58. A battery comprising a cathode, an anode and an electrolyte, said cathode further comprising the material of claim 45.
